(19) United States
(12) Patent Application Publication
(10) Pub. No.: US 2016/0072640 A1
(43) Pub. Date: Mar. 10, 2016

(54) MAC COPY IN NODES DETECTING FAILURE IN A RING PROTECTION COMMUNICATION NETWORK

(71) Applicants: Juan Yang, Beijing (CN); Yaping Zhou, Beijing (CN); Ke Lin, Beijing (CN)

(72) Inventors: Juan Yang, Beijing (CN); Yaping Zhou, Beijing (CN); Ke Lin, Beijing (CN)

(73) Assignee: TELEFONAKTIEBOLAGET L M ERICSSON (PUBL), Stockholm (SE)

(21) Appl. No.: 14/388,408

(22) PCT Filed: Mar. 29, 2012
(86) PCT No.: PCT/CN2012/073231

§ 371 Date: Sep. 3, 2015

(51) Int. Cl. H04L 12/437; H04L 29/12; H04L 12/801; H04L 12/755

(52) U.S. Cl. CPC H04L 12/437; H04L 45/021; H04L 61/6022; H04L 47/12

(57) ABSTRACT

Embodiments of the present invention provide a method and system for reducing congestion on a communication network. The communication network includes a network node having a first port and a second port. The network node is associated with forwarding data including first port forwarding data identifying at least one node accessible via the first port, and second port forwarding data identifying at least one node accessible via the second port. A failure associated with one of the first port and the second port is determined. The forwarding data corresponding to the other of the first port and the second port not associated with the failure, is updated with the one of the first port forwarding data and second port forwarding data corresponding to the one of the first port and the second port associated with the failure.

### TECHNICAL FIELD

The present invention relates to network communications, and in particular to a method and system for forwarding data in a ring-based communication network.

### BACKGROUND OF THE INVENTION

Ethernet Ring Protection (“ERP”), as standardized according to International Telecommunication Union (“ITU”) specification ITU-T G.8032, seeks to provide sub-50 millisecond protection for Ethernet traffic in a ring topology while simultaneously ensuring that no loops are formed at the Ethernet layer. Using the ERP standard, a node called the Ring Protection Link (“RPL”) owner node blocks one of the ports, known as the RPL port, to ensure that no loop forms for the Ethernet traffic. As such, loop avoidance may be achieved by having traffic flow on all but one of the links in the ring, the RPL link. Ring Automated Protection Switching (“R-APS”) messages are used to coordinate the activities of switching the RPL link on or off.

Any failure along the ring triggers an R-APS Signal Fail message, also known as a Failure Indication Message (“FIM”), from the nodes adjacent to or the nodes that detected the failed link. The nodes adjacent to the failed link or the nodes that detected the failed link block one of their ports, the port that detected the failed link or failed node. On receiving a FIM message, the RPL owner node unblocks the RPL port. Because at least one link or node has failed somewhere in the ring, there can be no loop formation in the ring when unblocking the RPL link Additionally, at the time of protection switching for a failure or a failure recovery, all ring nodes in the ring clear or flush their current forwarding data, which may include a forwarding database (“FDB”) that contains the routing information from the point of view of the current node. For example, each node may remove all learned MAC addresses stored in their FDBs.

If a packet arrives at a node for forwarding during the time interval between the FDB flushing and establishing of a new FDB, the node will not know where to forward the packet. In this case, the node simply floods the ring by forwarding the packet through each port, except the port which received the packet. This results in poor ring bandwidth utilization during a ring protection and recovery event, and in lower protection switching performance. When the FDBs are flushed, the network may experience a large amount of traffic flooding, which may be several times greater than the regular traffic. Hence, the conventional FDB flush may put a lot of stress on the network by utilizing large amounts of bandwidth. Further, during an FDB flush, the flooding traffic volume may be far greater than the link capacity, causing a high volume of packets to get lost or be delayed. Therefore, it is desirable to avoid flushing the FDB whenever possible.

What is needed is a method and system for discovering the topology composition of a network upon protection and recovery switching without flooding the network.

### SUMMARY OF THE INVENTION

The present invention advantageously provides a method and system for discovering the topology of a network. In accordance with one aspect, the invention provides a network node that includes a first port, a second port, a memory storage device and a processor in communication with the first port, the second port and the memory storage device. The memory storage device is configured to store forwarding data, the forwarding data including first port forwarding data identifying at least one node accessible via the first port, and second port forwarding data identifying at least one node accessible via the second port. The processor determines a failure associated with one of the first port and the second port. The processor updates the forwarding data corresponding to the other of the first port and the second port not associated with the failure, with the one of the first port forwarding data and second port forwarding data corresponding to the one of the first port and the second port associated with the failure.

In accordance with another aspect, the present invention provides a method for reducing congestion on a communication network. The communication network includes a network node having a first port and a second port. The network node is associated with forwarding data including first port forwarding data identifying at least one node accessible via the first port, and second port forwarding data identifying at least one node accessible via the second port. A failure associated with one of the first port and the second port is determined. The forwarding data corresponding to the other of the first port and the second port not associated with the failure, is updated with the one of the first port forwarding data and second port forwarding data corresponding to the one of the first port and the second port associated with the failure.

According to another aspect, the invention provides a computer readable storage medium storing computer readable instructions that when executed by a processor, cause the processor to perform a method that includes storing forwarding data associated with a network node. The forwarding data includes first port forwarding data identifying at least one node accessible via a first port of the network node, and second port forwarding data identifying at least one node accessible via a second port of the network node. A failure associated with one of the first port and the second port is determined. The forwarding data corresponding to the other of the first port and the second port not associated with the failure, is updated with the one of the first port forwarding data and second port forwarding data corresponding to the one of the first port and the second port associated with the failure.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary network constructed in accordance with the principles of the present invention;

FIG. 2 is a diagram of exemplary forwarding data for node B 12B, constructed in accordance with the principles of the present invention;

FIG. 3 is a diagram of exemplary forwarding data for node C 12C, constructed in accordance with the principles of the present invention;

FIG. 4 is a block diagram of the exemplary network of FIG. 1 with a link failure, constructed in accordance with the principles of the present invention;

FIG. 5 is a diagram of exemplary forwarding data for node B 12B after a link failure, constructed in accordance with the principles of the present invention;

FIG. 6 is a diagram of exemplary forwarding data for node C 12C after a link failure, constructed in accordance with the principles of the present invention;

FIG. 7 is a block diagram of the exemplary network of FIG. 1 with additional detail for node D 12D, constructed in accordance with the principles of the present invention;

FIG. 8 is a diagram of exemplary forwarding data for node B 12B, constructed in accordance with the principles of the present invention;

FIG. 9 is a diagram of exemplary forwarding data for node D 12D, constructed in accordance with the principles of the present invention;

FIG. 10 is a block diagram of the exemplary network of FIG. 1 showing a failure on node C 12C, constructed in accordance with the principles of the present invention;

FIG. 11 is a diagram of exemplary forwarding data for node B 12B, constructed in accordance with the principles of the present invention;

FIG. 12 is a diagram of exemplary forwarding data for node D 12D, constructed in accordance with the principles of the present invention;

FIG. 13 is a block diagram of an exemplary network with a primary ring and a sub-ring topology, constructed in accordance with the principles of the present invention;

FIG. 14 is a diagram of exemplary forwarding data for node E 12E, constructed in accordance with the principles of the present invention;

FIG. 15 is a diagram of exemplary forwarding data for node F 12F, constructed in accordance with the principles of the present invention;

FIG. 16 is a block diagram of the exemplary network of FIG. 13 showing a failure of a link in the sub-ring, constructed in accordance with the principles of the present invention;

FIG. 17 is a diagram of exemplary forwarding data for node E 12E after a link failure, constructed in accordance with the principles of the present invention;

FIG. 18 is a diagram of exemplary forwarding data for node F 12F after a link failure, constructed in accordance with the principles of the present invention;

FIG. 19 is a block diagram of an exemplary network with a primary ring and a sub-ring topology, constructed in accordance with the principles of the present invention;

FIG. 20 is a diagram of exemplary forwarding data for node E 12E, constructed in accordance with the principles of the present invention;

FIG. 21 is a block diagram of the exemplary network of FIG. 19 with a link failure in the sub-ring, constructed in accordance with the principles of the present invention;

FIG. 22 is a diagram of exemplary forwarding data for node E 12E after a link failure, constructed in accordance with the principles of the present invention;

FIG. 23 is a block diagram of an exemplary node, constructed in accordance with the principles of the present invention; and

FIG. 24 is a flow chart of an exemplary process for updating forwarding data, constructed in accordance with the principles of the present invention.

### DETAILED DESCRIPTION OF THE INVENTION

Before describing in detail exemplary embodiments that are in accordance with the present invention, it is noted that the embodiments reside primarily in combinations of apparatus components and processing steps related to implementing a system and method for discovering the topology of a network. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

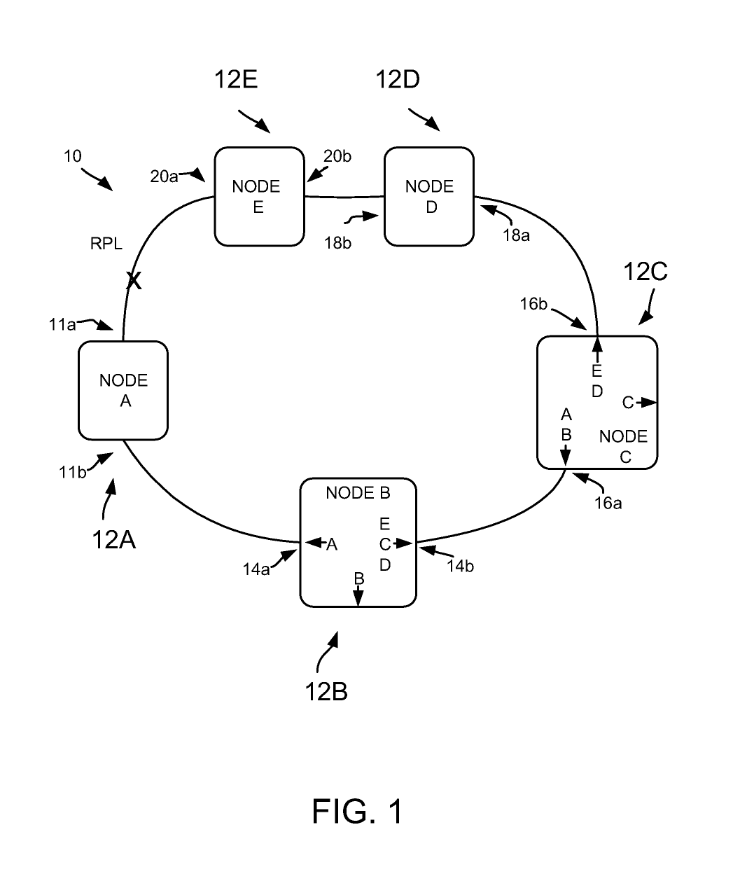

Referring now to the drawing figures in which reference designators refer to like elements, there is shown in FIG. 1 a schematic illustration of a system in accordance with the principles of the present invention, and generally designated as “10”. As shown in FIG. 1, system 10 includes a network of nodes arranged in a ring topology, such as an Ethernet ring network topology. The ring may include node A 12A, node B 12B, node C 12C, node D 12D and node E 12E. Nodes A 12A, B 12B, C 12C, D 12D and E 12E are herein collectively referred to as nodes 12. Each node may have ring ports used for forwarding traffic on the ring. Each node 12 may be in communication with adjacent nodes via a link connected to a port on node 12. Although FIG. 1 shows exemplary nodes A 12A-E 12E arranged in a ring topology, the invention is not limited to such, as any number of nodes 12 may be included, as well as different network topologies. Further, the invention may be applied to a variety of network sizes and configurations.

The link between node A 12A and node E 12E may be an RPL. The RPL may be used for loop avoidance, causing traffic to flow on all links but the RPL. Under normal conditions the RPL may be blocked and not used for service traffic. Node A 12A may be an RPL owner node responsible for blocking traffic on an RPL port at one end of the RPL, e.g. RPL port 11a. Blocking one of the ports may ensure that there is no loop formed for the traffic in the ring. Node E 12E at the other end of the RPL link may be an RPL partner node. RPL partner node E 12E may hold control over the other port connected to the RPL, e.g. port 20a. Normally, RPL partner node E 12E holds port 20a blocked. Node E 12E may respond to R-APS control frames by unblocking or blocking port 20a.

In an exemplary embodiment, when a packet travels across the network, the packet may be tagged to indicate which VLAN to use to forward the packet. In an exemplary embodiment, all ports of nodes 12 may belong to VLANs X, M, Y and Z, so that all nodes 12 may forward ingress packets inside the ring that are tagged for at least one of VLANs X, M, Y and Z.

Node 12 may look up forwarding data in, for example, a forwarding database, to determine how to forward the packet. Forwarding data may be constructed dynamically by learning the source MAC address in the packets received by the ports of node 12. Node 12 may learn forwarding data by examining the packets to learn information about the source node, such as the MAC address. Forwarding data may include any information used to identify a packet destination or a node, such as a port on node 12, a VLAN identifier and a MAC address, among other information.

Each one of nodes A 12A-E 12E may include ports for forwarding traffic. For example, node B 12B may include port 14a and port 14b, node C 12C may include port 16a and port 16b, and node D 12D may include port 18a and port 18b. Each one of the ports of nodes A 12A-E 12E may be associated with forwarding data. Also, although the drawing figures show those nodes available via the listed ports, it is understood that the node listing is used as shorthand herein and refers to all source MAC addresses included in the ingress packets at the listed node. For example, although node B 12B shows “A” accessible via port 14a, this reference encompasses all source MAC addresses of ingress packets at node A 12A.

Node 12 may receive a packet and determine which egress port to use in order to forward the packet. The packet may be associated with identification information identifying a node, such as identification information identifying a destination node. Node identification information identifying the destination node, i.e., the destination identification, may be used to forward the packet to the destination node. Node 12 may add a source identifier (such as the source MAC address of the node that sent the packet), an ingress port identifier, and bridging VLAN information as a new entry to the forwarding data. For example, the source MAC address, the ingress port identifier and the bridging VLAN identification may be added as a new entry to the forwarding database. Forwarding data may include, in addition to the identification information identifying a node, such as a MAC address, and VLAN identifications, any information related to the topology of the network.

Forwarding data may determine which port may be used to send packets across the network. Node 12 may determine the egress port to which the packets are to be routed by examining the destination details of the packet's frame, such as the MAC address of the destination node. If there is no entry in the forwarding database that includes a destination identifier, such as the MAC address of the destination node included in the packets received in the bridging VLAN, the packets will be flooded to all ports except the port from which the packets were received in the bridging VLAN on node 12. Therefore, when the address of the destination node of a received packet is not found in the forwarding data, the packet may be flooded to all ports of node 12, except the one port from which the packet was received, and when the address of the destination node is found in the forwarding data, the packet will be forwarded directly to the port associated with the entry instead of flooding the packets.

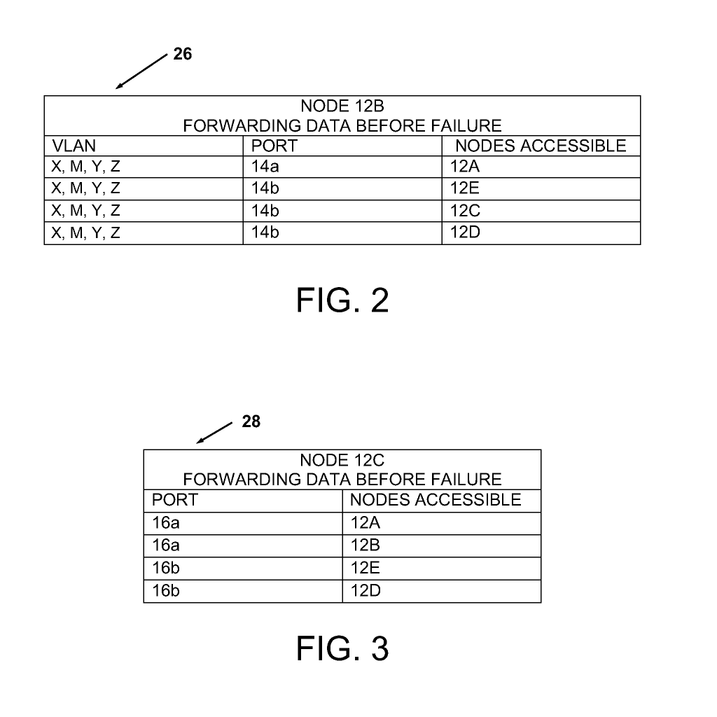

FIG. 2 is exemplary forwarding data 26 for node B 12B in a normal state of ERP, i.e., when there is no failure on the ring. Forwarding data 26 may contain routing configuration from the point of view of node B 12B, such as which ports of node B 12B to use when forwarding a received packet, depending on the node destination identification associated with the received packet, which may be the destination MAC address associated with the received packet.

By way of example, forwarding data 26 indicates that packets received for node A 12A, for example, received packets by node B 12B having as destination identification the MAC address of node A 12 A, will be forwarded through port 14a. Forwarding data 26 further indicates that packets received for nodes E 12E, C 12C and D 12D, for example, packets received by node B 12B having as destination identification the MAC address of at least one of destination nodes E 12E, C 12C and D 12D, will be forwarded through port 14b. As such, if node B 12B receives a packet for node A 12A, i.e., node A 12A is the destination node, node B 12B may use port 14a to send the packet to node A 12A. Similarly, if node B 12B receives a packet that indicates node E 12E as the destination node, node B 12B may send the packet via port 14b.

FIG. 3 is exemplary forwarding data 28 for node C 12C in normal state of ERP, i.e., when there is no failure on the ring. Forwarding data 28 may contain forwarding information regarding which ports of node C 12C to use in order to forward a received packet depending on the node identification associated with the packet, such as a destination MAC address associated with the received packet.

Forwarding data 28 may indicate that packets received for at least one of nodes A 12A and B 12B, for example, received packets by node C 12C having as destination identification the MAC address of either nodes A 12A or B 12B, will be forwarded through port 16a. Forwarding data 28 further indicates that packets received for nodes E 12E and D 12D, for example, packets received by node C 12C that are associated with a node identification that may include the MAC address of at least one of destination nodes E 12E and D 12D, are forwarded through port 16b. As such, if node C 12C receives a packet that indicates node A 12A as the destination node, node C 12C may use port 16a to send the packet to node A 12A. Similarly, if node C 12C receives a packet that indicates node E 12E as the destination node, node C 12C may send the packet via port 16b. For ease of understanding, VLAN information has not been included in FIGS. 3, 5, 6, 8, 9, 11, 12, 14, 15, 17, 18, 20 and 22. It is understood that the intentional omission of VLAN information in FIGS. 3, 5, 6, 8, 9, 11, 12, 14, 15, 17, 18, 20 and 22 is meant to ease understanding by simplifying the description and in no way limits the invention, as forwarding data may include MAC address information and VLAN information, among other forwarding/routing information.

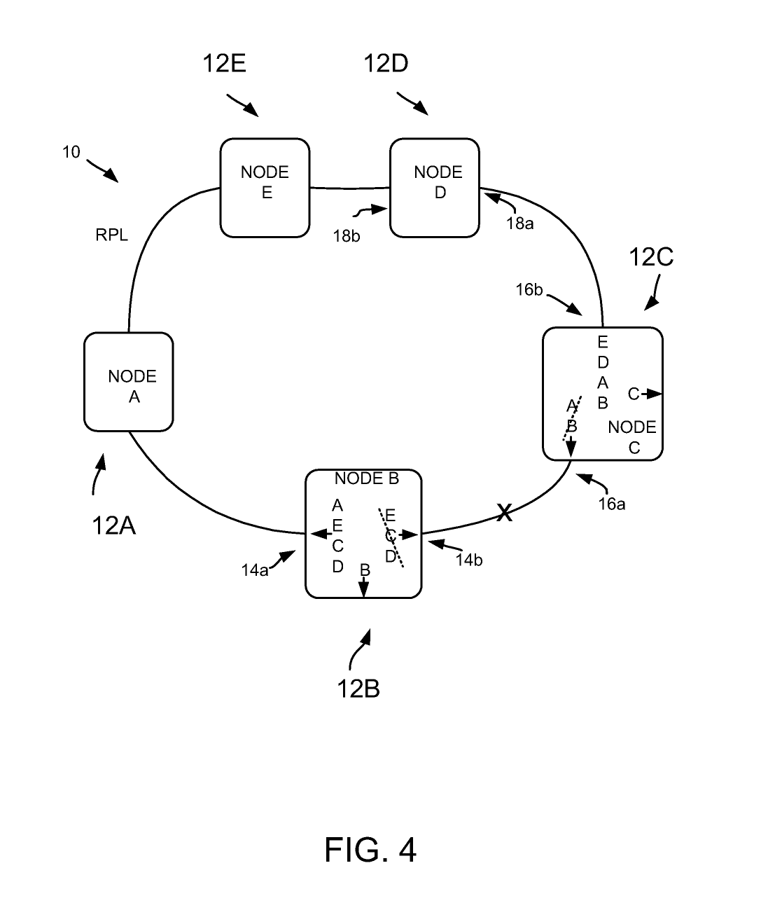

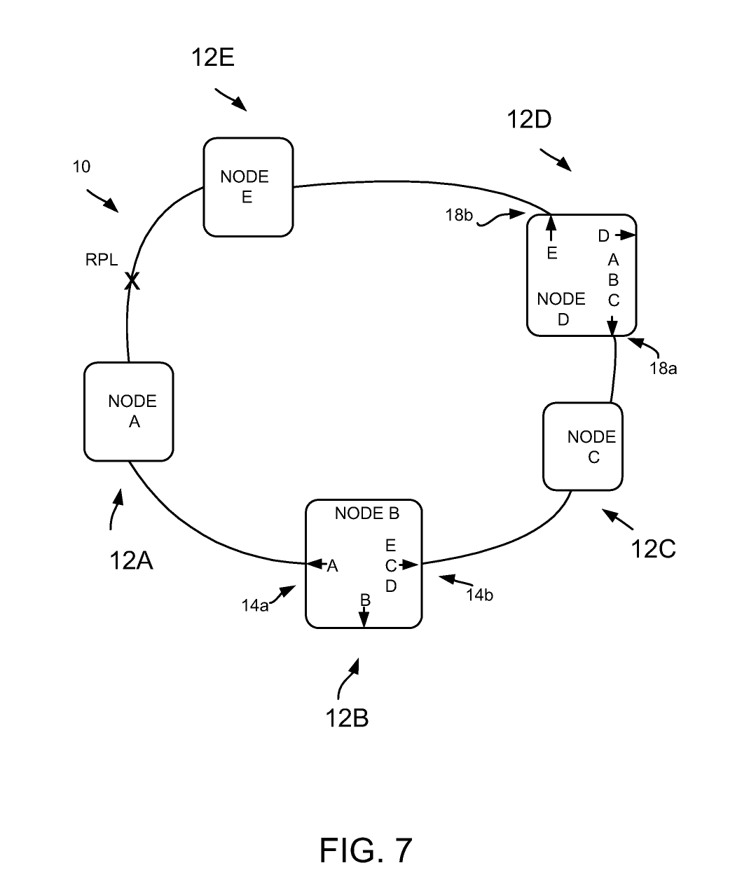

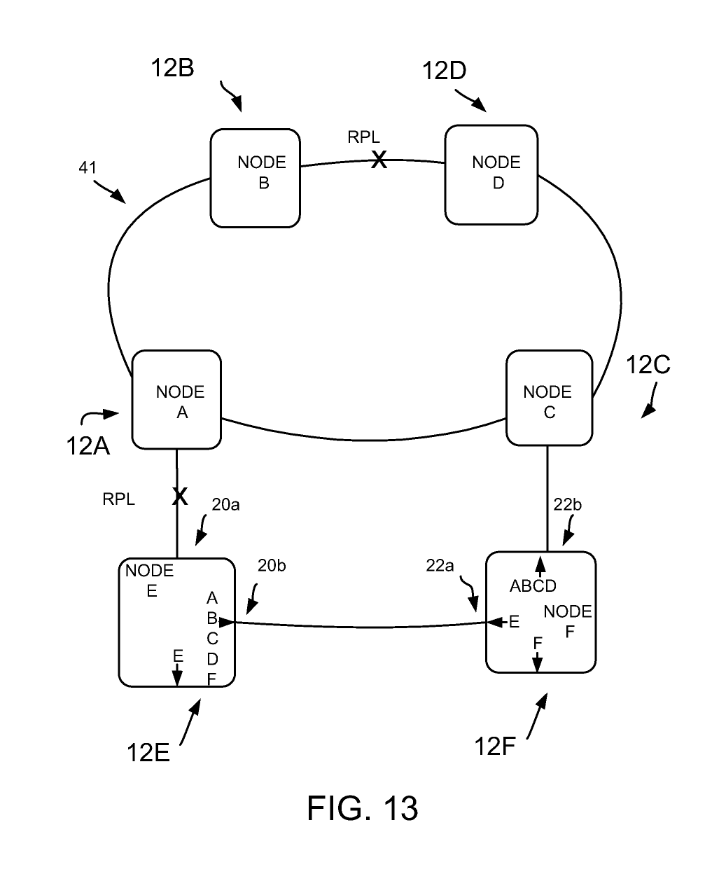

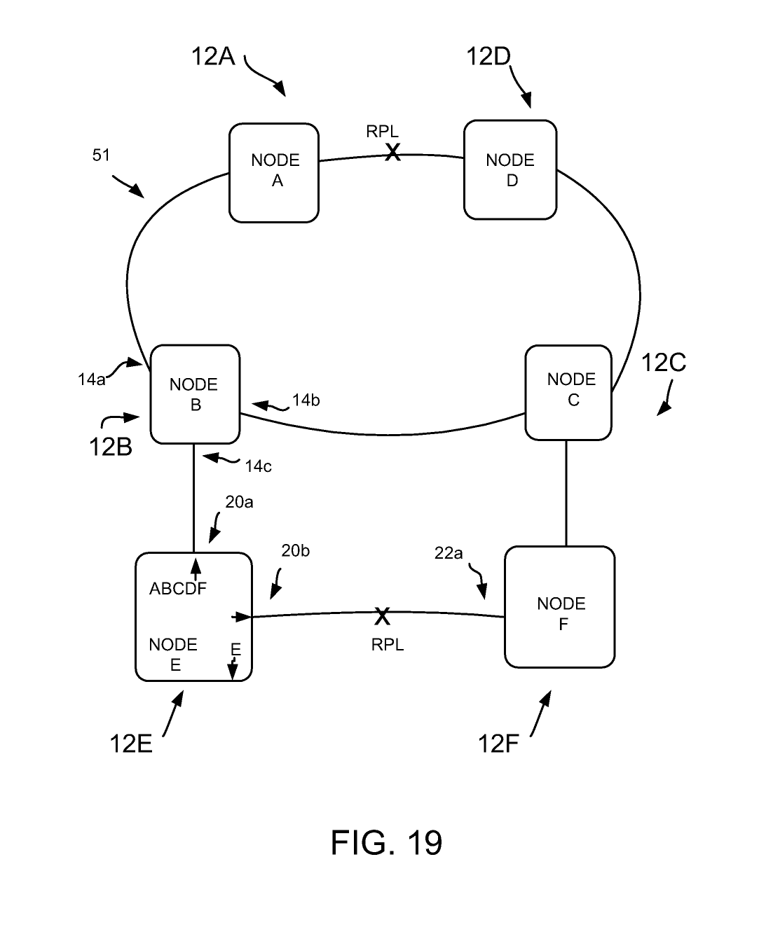

Different embodiments of the present invention will be discussed below. For example, FIGS. 4-6 illustrate an embodiment in which nodes arranged in a ring topology experience a failure in a link between two nodes, e.g., nodes B 12B and C 12C. FIGS. 7-12 illustrate an embodiment where nodes arranged in a ring topology experience a failure of a node, e.g. node C 12C. FIGS. 13-18 illustrate an embodiment where nodes arranged in a primary ring and a sub-ring topology experience a failure in a line between sub-ring normal nodes, e.g. nodes E 12E and F 12F. FIGS. 19-22 illustrate an embodiment where nodes arranged in a primary ring and a sub-ring topology experience a failure in a line between a normal sub-ring node and an interconnected node, e.g. nodes E 12E and B 12B. The invention applies to different network configurations and sizes, and is not limited to the embodiments discussed.

FIG. 4 is a diagram of the network of FIG. 1 showing a failure in the link between nodes B 12B and C 12C. When a link or node in the ring fails, a protection switching mechanism may redirect the traffic on the ring. A failure along the ring may trigger an R-APS signal fail (“R-APS SF”) message along both directions from the nodes which detected the failed link or failed node. The R-APS message may be used to coordinate the blocking or unblocking of the RPL port by the RPL owner and the partner node.

In this exemplary embodiment, nodes B 12B and C 12C are the nodes adjacent to the failed link Nodes B 12B and C 12C may block their corresponding port adjacent to the failed link, i.e., node B 12B may block port 14b and node C 12C may block port 16a, to prevent traffic from flowing through those ports. The RPL owner node may unblock the RPL, so that the RPL may be used to carry traffic. In this exemplary embodiment, node A 12A may be the RPL owner node and may unblock its RPL port. RPL partner node E 12E may also unblock its port adjacent to the RPL when it receives an R-APS SF message.

According to the G.8032 standard, all nodes flush their forwarding database to re-learn MAC addresses in order to redirect the traffic after a failure in the ring. However, flushing the forwarding databases may cause traffic flooding in the ring, given that thousands of MAC addresses may need to be relearned. Instead of following the convention of having all nodes in the ring flushing their forwarding database when a failure occurs, in an embodiment of the invention, some nodes may flush their forwarding data, and some nodes may not flush their forwarding data.

Nodes that detected the failed link/failed node or are adjacent to the failed link or failed node may not need to flush their forwarding data, while other nodes that are not adjacent to the failed link or failed node may need to flush their forwarding data. Forwarding data may include a FDB. The other nodes may need to flush their forwarding data to re-learn the topology of the network after failure. By having some nodes not flush their forwarding databases, the overall bandwidth utilization of the ring and the protection switching performance of the ring may be improved.

For example, given the failure in the link between nodes B 12B and C 12C, as shown in FIG. 4, nodes A 12A, D 12D and E 12E may flush their forwarding data. However, nodes B 12B and C 12C need not flush their forwarding data. Instead, nodes B 12B and C 12C may each copy forwarding data associated with their port adjacent to the failed link to the forwarding data associated with their other port, i.e., the port not adjacent to the failed link. A port adjacent to the failed link may be the port that detected the link failure.

For example, before the link failure, traffic ingress of node B 12B associated with a node identification for nodes E 12E, C 12C and D 12D, such as for example, the MAC address of at least one of destination nodes E 12E, C 12C and D 12D, will be forwarded to the at least one of nodes E 12E, C 12C and D 12D via port 14b of node B 12B. Packets received for node A 12A, for example, received packets by node B 12B that are associated with a node identification that may include the MAC address of node A 12 A, will be forwarded via port 14a of node B 12B. Therefore, before the failure, packets received by node B 12B for nodes E 12E, C 12C and D 12D were forwarded using port 14b, and packets for node A 12A were forwarded using port 14a.

After the failure, node B 12B copies the forwarding data associated with the port that detected the failure, i.e., port 14b adjacent to the failure, to forwarding data associated with port 14a. As such, the forwarding data of node B 12B after failure will indicate that ingress traffic associated with destination identification for at least one of nodes A 12A, E 12E, C 12C and D 12D, such as the MAC address of at least one of destination nodes A 12A, E 12E, C 12C and D 12D, will be forwarded to port 14a, instead of flooding to both port 14a and port 14b.

Similarly, node C 12C may copy forwarding data associated with port 16a, which includes identification data for nodes A 12A and B 12B previously accessible via port 16a, such as the MAC address of nodes A 12A and B 12B, to forwarding data associated with port 16b. Nodes B 12B and C 12C may send out R-APS, which may include a Signal Failure and a flush request, to coordinate protection switching in the ring, as well as redirect the traffic.

By copying forwarding data associated with one port to the other port, such as the forwarding data of the port that detected the failure to the other port, an embodiment of the present invention advantageously avoids the need to clear/flush the forwarding data of all nodes in the ring when there is a failure on the ring. Forwarding data may include identification information of nodes, such as MAC addresses of destination nodes, source nodes, VLAN identifications, etc.

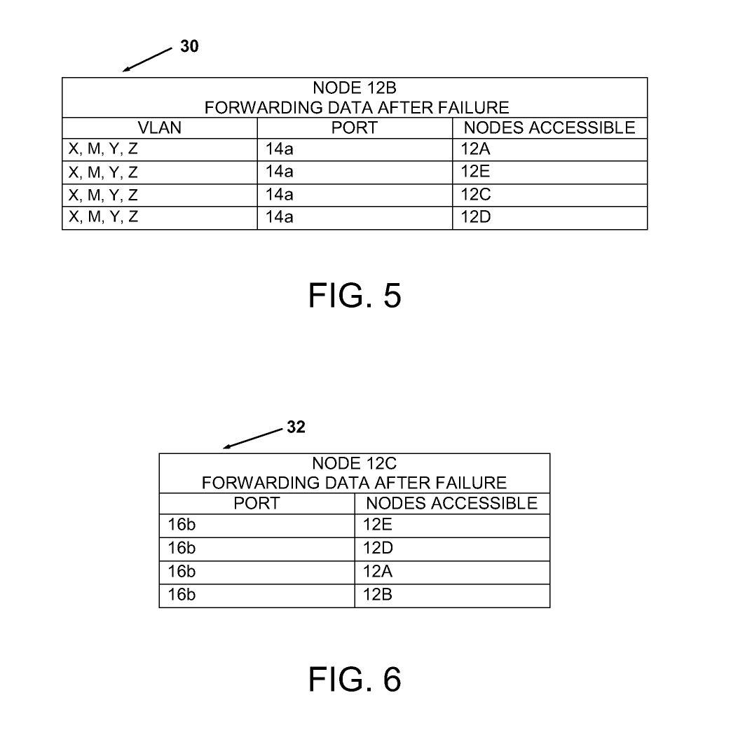

FIG. 5 is exemplary forwarding data 30 for node B 12B after failure on the ring, i.e., after the link between nodes B 12B and C 12C failed. Forwarding data 30 may indicate that packets received for at least one of nodes A 12A, E 12E, C 12C will be forwarded through port 14a. As such, if node B 12B receives a packet that indicates node E 12E as the destination node, node B 12B may use port 14a to send the packet to node E 12E. Forwarding data 30 may indicate that all ports of nodes 12 may belong to VLANs X, M, Y and Z, so that all nodes 12 may forward ingress packets inside the ring that are tagged for at least one of VLANs X, M, Y and Z.

FIG. 6 is exemplary forwarding data 32 for node C 12C after failure on the ring, i.e., after the link between nodes B 12B and C 12C failed. Forwarding data 32 may indicate that packets received for nodes E 12E, D 12D, A 12A and B 12B, for example, packets received by node C 12C that are associated with a node identification that may include the MAC address of at least one of destination nodes E 12E, D 12D, A 12A and B 12B, are forwarded through port 16b. As such, if node C 12C receives a packet that indicates node A 12A as the destination node, node C 12C may use port 16b to send the packet to node A 12A.

FIG. 7 is a diagram of the network of FIG. 1, showing additional detail with respect to node D 12D. In this exemplary embodiment, when there is no failure on the ring, packets received by node D 12D for node E 12E, for example, packets that are associated with a node identification that may include the MAC address of destination node E 12E, will be forwarded to port 18b. Packets received for nodes A 12A, B 12B and C 12C, for example, packets that are associated with a node identification that may include the MAC address of at least one of destination nodes A 12A, B 12B and C 12C will be forwarded via port 18a.

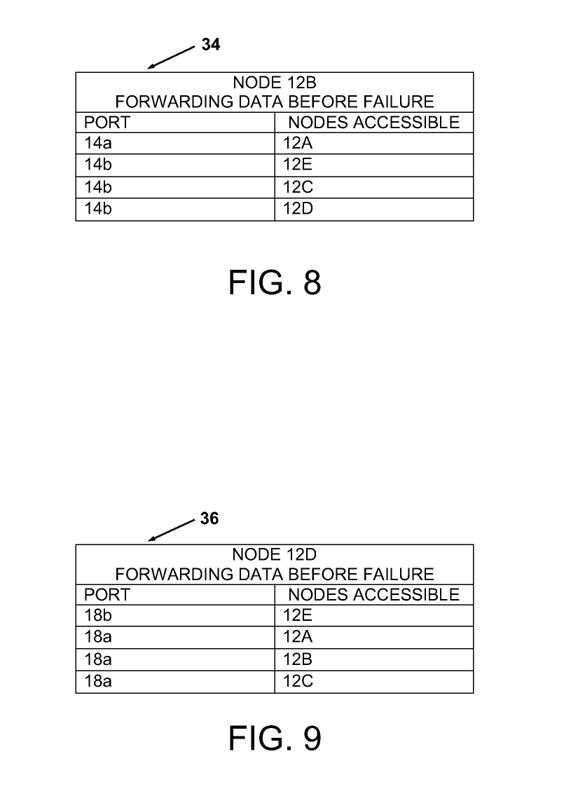

FIG. 8 is exemplary forwarding data 34 for node B 12B during normal state of the ring, i.e., when there is no failure on the ring. Forwarding data 34 may indicate that packets for node A 12A, for example, packets received by node B 12B that are associated with a node identification that may include the MAC address of destination node A 12A, will be forwarded through port 14a. Packets for nodes E 12E, C 12C and D 12D, for example, packets received by node B 12B that are associated with a node identification that may include the MAC address of at least one of destination nodes E 12E, C 12C and D 12D will be forwarded through port 14b. As such, if node B 12B receives a packet that indicates node A 12A as the destination node, node B 12B may use port 14a to send the packet to node A 12A. Similarly, if node B 12B receives a packet that indicates node E 12E as the destination node, node B 12B may send the packet via port 14b.

FIG. 9 is exemplary forwarding data 36 for node D 12D during normal state of the ring, i.e., when there is no failure on the ring. Forwarding data 36 may indicate that packets received for node E 12E, for example, packets received by node D 12D that are associated with a node identification that may include the MAC address of destination node E 12E, will be forwarded through port 18b. Forwarding data 36 may also indicate that packets destined for at least one of nodes A 12A, B 12B and C 12C, for example, packets received by node D 12D that are associated with a node identification that may include the MAC address of at least one of destination nodes A 12A, B 12B and C 12C are forwarded through port 18a. As such, if node D 12D receives a packet that indicates node E 12E as the destination node, node D 12D may use port 18b to send the packet to node E 12E. Similarly, if node D 12D receives a packet that indicates node C 12C as the destination node, node D 12D may send the packet via port 18a.

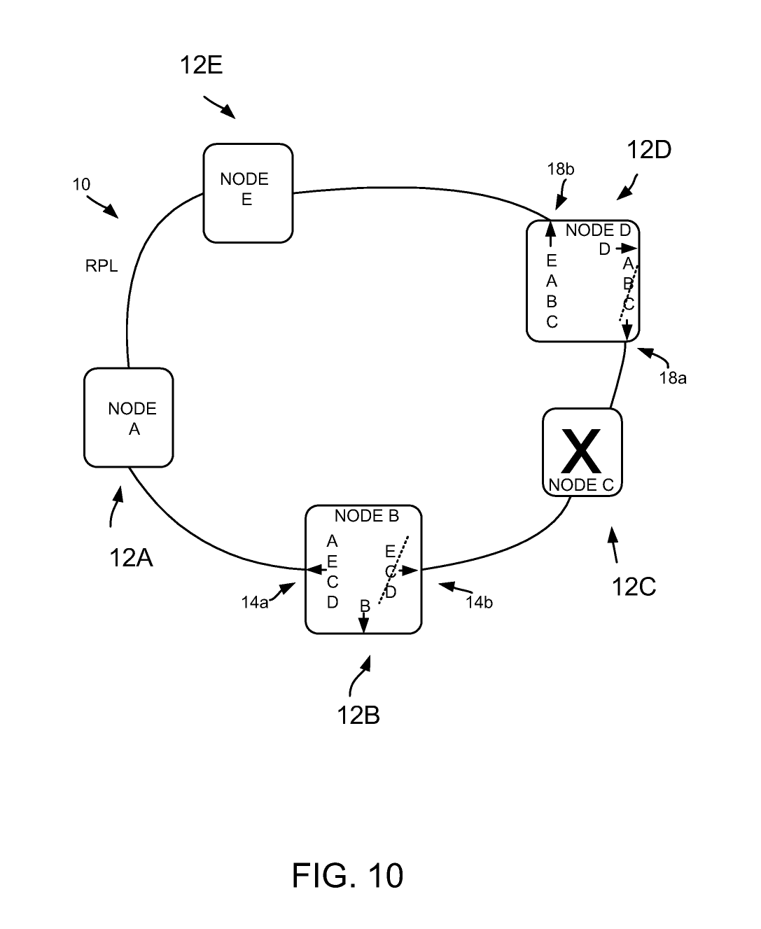

FIG. 10 is a diagram of the network of FIG. 7 showing failure of node C 12C. A node failure may be equivalent to a two link failure. When a node in the ring fails, a protection switching mechanism may redirect traffic on the ring. A failure along the ring may trigger an R-APS signal fail (“R-APS SF”) message along both directions from the nodes that detected the failure. In this exemplary embodiment, nodes B 12B and D 12D are the nodes that detected the failure and are adjacent to the failed node. Nodes B 12B and D 12D may block a port adjacent to the failed link, i.e., node B 12B may block port 14b and node D 12D may block port 18a. Additionally, upon receiving an R-APS SF message, the RPL owner node and the partner node may unblock the RPL, so that the RPL may be used for carrying traffic.

In this exemplary embodiment, instead of having all nodes clearing or flushing their forwarding data when a failure occurs, nodes that detected the failure may not need to flush their forwarding data. Instead of flushing their forwarding data, the nodes that detected the failure may copy the forwarding data learned on the port that detected the failure, to the forwarding data of the other port. All other nodes in the ring that did not detect the failed node may flush their corresponding forwarding data upon receiving an R-APS SF message. This embodiment of the present invention may release nodes that detected the failure or nodes adjacent to the failure from flushing their forwarding data. As such, no flushing of forwarding data may be required for nodes B 12B and D 12D, which may significantly improve the overall bandwidth utilization of the ring when a failure occurs, as the traffic may still be redirected in the ring successfully.

For example, when node C 12C fails, nodes A 12A and E 12E may flush their forwarding data, but nodes B 12B and D 12D may not flush their forwarding data. Instead, nodes B 12B and D 12D may copy the forwarding data learned on the port that detected the failure, to the forwarding data associated with the other port. Before the node failure, a packet received at node B 12B for at least one of nodes E 12E, C 12C and D 12D, for example, a packet associated with a node identification that may include the MAC address of at least one of destination nodes E 12E, C 12C and D 12D, was forwarded via port 14b of node B 12B. Packets received at node B 12B for node A 12A, for example, a packet associated with a node identification that may include the MAC address of destination node A 12A, was forwarded via port 14a of node B 12B. After the failure, node B 12B copies the forwarding data learned on the port that detected the failure, i.e., port 14b, to port 14a. As such, the forwarding data of node B 12B after the failure may indicate that packets addressed to nodes A 12A, E 12E, C 12C and D 12D are routed through node 14a.

Likewise, node D 12D copies forwarding data learned on port 18a to forwarding data associated with port 18b. Since forwarding data associated with port 18a indicated that packets received at node D 12D and addressed to at least one of nodes A 12A, B 12B and C 12C were, previously to the failure of node C 12C, forwarded via port 18a, this forwarding data gets copied to the forwarding data of port 18b. Previous to the failure, the forwarding data associated with port 18b had packets addressed to node E 12E as being forwarded through port 18b. After copying the forwarding data of port 18a to the forwarding data of port 18b, not only are packets addressed to node E 12E forwarded via port 18b, but also packets addressed to nodes A 12A, B 12B and C 12C.

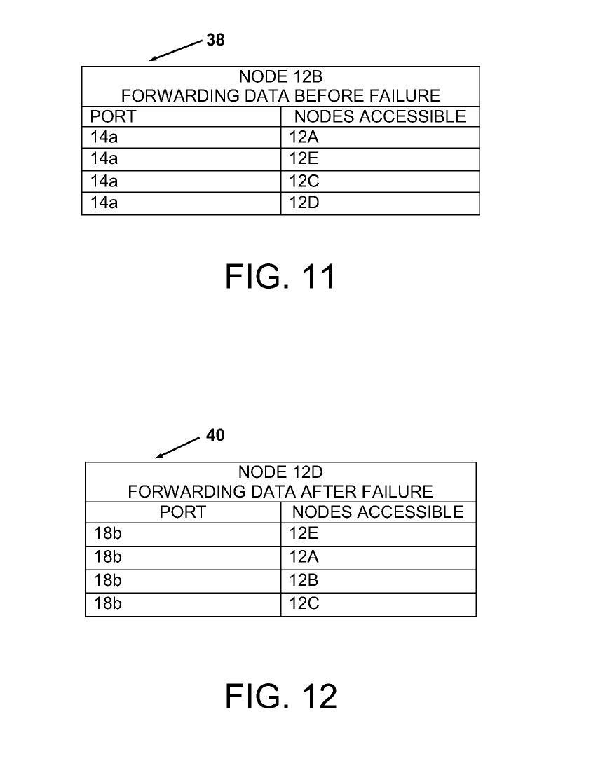

FIG. 11 is exemplary forwarding data 38 for node B 12B after the failure of node C 12C. Forwarding data 38 may indicate that packets received at node B 12B that are associated with a node identification that may include the MAC address of at least one of destination nodes A 12A, E 12E, C 12C and D 12D will be forwarded through port 14a. As such, if node B 12B receives a packet that indicates node E 12E as the destination node, node B 12B may use port 14a to send the packet to node E 12E.

FIG. 12 is exemplary forwarding data 40 for node D 12D after the failure of node C 12C. Forwarding data 40 may indicate that packets received for nodes E 12E, A 12A, B 12B and C 12C, for example, packets received that are associated with a node identification that may include the MAC address of at least one of destination nodes E 12E, A 12A, B 12B and C 12C, will be forwarded through port 18b. As such, if node D 12D receives a packet that indicates node A 12A as the destination node, node D 12D may use port 18b to send the packet to node A 12A. No packets may be sent via port 18a.

FIG. 13 is a schematic illustration of exemplary network 41. Network 41 includes nodes arranged in a primary ring and a sub-ring topology. The primary ring may include node A 12A, node B 12B, node C 12C and node D 12D. The sub-ring may include node E 12E and node F 12F. Node B 12B and node C 12C are called interconnecting nodes that interconnect the primary ring with the sub-ring. Each node 12 may be connected via links to adjacent nodes, i.e., a link may be bounded by two adjacent nodes. Although FIG. 13 shows exemplary nodes A 12A-E 12E, the invention is not limited to such, as any number of nodes may be included in the ring. Further, the invention may be applied to a variety of network sizes and configurations.

In an exemplary embodiment, the link between node B 12B and node E 12E may be the RPL for the sub-ring, and the link between node A 12A and D 12D may be the RPL for the primary ring. Under normal state, both RPLs may be blocked and not used for service traffic. Node A 12A may be an RPL owner node for the primary ring, and may be configured to block traffic on one of its ports at one end of the RPL. Blocking the RPL for the primary ring may ensure that there is no loop formed for the traffic in the primary ring. Node E 12E may be the RPL owner node for the sub-ring, and may be configured to block traffic on port 20a at one end of the RPL for the sub-ring. Blocking the RPL for the sub-ring may ensure that there is no loop formed for the traffic in the sub-ring. Each one of nodes A 12A-F 12F may include two ring ports for forwarding traffic. For example, node E 12E may include port 20a and port 20b, and node F 12F may include port 22a and port 22b. Each one of the ports of nodes A 12A-F 12F may be associated with forwarding data.

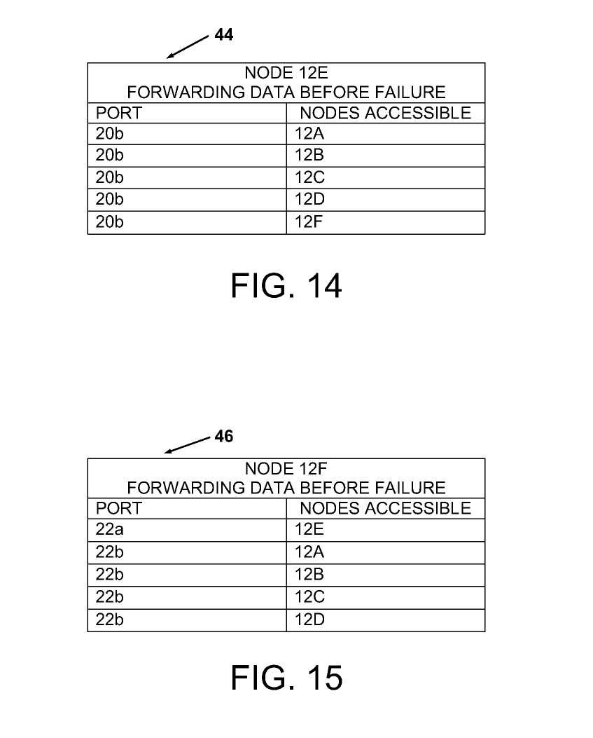

FIG. 14 is exemplary forwarding data 44 for node E 12E during normal stat of the ring, i.e., when there is no failure on either the primary ring or the sub-ring. Forwarding data 44 may include information regarding which ports of node E 12E to use to forward packets. Forwarding data 44 may contain the routing configuration from the point of view of node E 12E. Forwarding data 44 may indicate that packets destined to at least one of nodes A 12A, B 12B, C 12C, D 12D and F 12F, for example, packets that are associated with a node identification that may include the MAC address of at least one of destination nodes A 12A, B 12B, C 12C, D 12D and F 12F, are forwarded through port 20b. As such, if node E 12E receives a packet that indicates node A 12A as the destination node, node E 12E may use port 20b to send the packet to node A 12A. Port 20a may be blocked, given that it is connected to the RPL of the sub-ring.

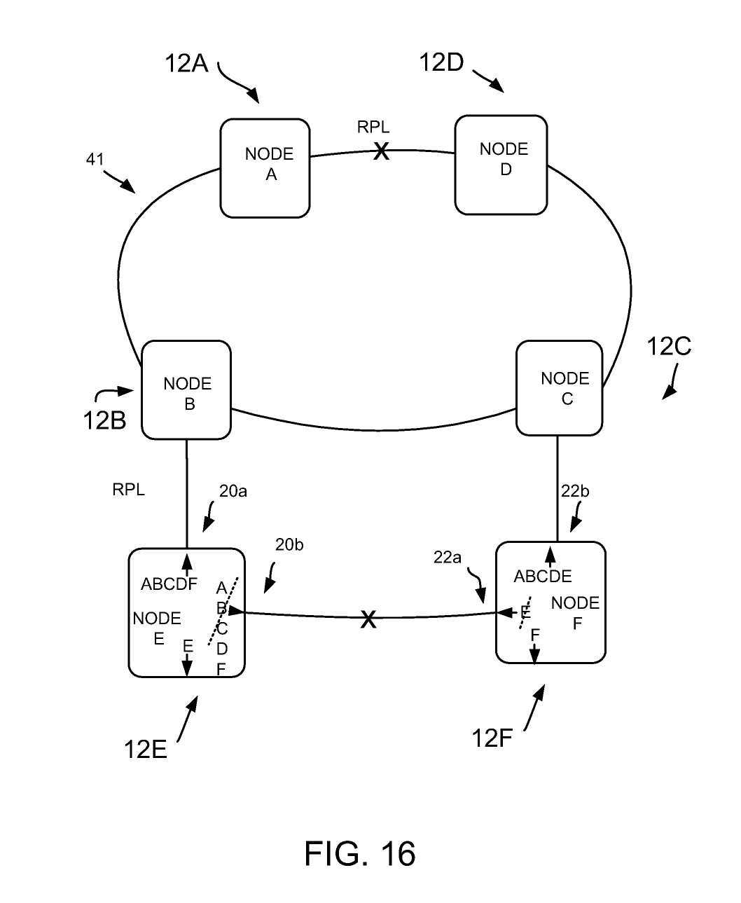

FIG. 15 is exemplary forwarding data 46 for node F 12F during normal state of the ring, i.e., when there is no failure on either the primary ring or the sub-ring. Forwarding data 46 may include information regarding which ports of node F 12F may be used to forward data to nodes 12. Forwarding data 46 may contain the routing configuration from the point of view of node F 12F and may indicate which nodes are accessible through which ports.

Forwarding data 46 may indicate that packets received by node F 12F and addressed to node E 12E, for example, packets that are associated with a node identification that may include the MAC address of destination node E 12E, are forwarded via port 22a. Packets addressed to at least one of nodes A 12A, B 12B, C 12C and D 12D, for example, packets that are associated with a node identification that may include the MAC address of at least one of destination nodes A 12A, B 12B, C 12C and D 12D, are routed through port 22b. As such, if node F 12F receives a packet that indicates node E 12E as the destination node, node F 12F may use port 22a to send the packet to node E 12E. Similarly, if node F 12F receives a packet that indicates node C 12C as the destination node, node F 12F may send the packet via port 22b.

FIG. 16 is a diagram of the network of FIG. 13 showing a failure on a line between sub-ring normal nodes E 12E and F 12F. Non-interconnected nodes are herein referred to as normal nodes. When a link in the ring fails, a protection switching mechanism may redirect traffic on the ring. Nodes that detected the failed link or nodes adjacent to the failed link, i.e., nodes E 12E and F 12F, may block their corresponding port that detected the failed link or is adjacent to the failed link. As such, node E 12E may block port 20b and node F 12F may block port 22a. The RPL owner node may be responsible for unblocking the RPL on the sub-ring, so that the RPL may be used for traffic. In this exemplary embodiment, the RPL owner node of the sub-ring, i.e., node E 12E, may unblock its RPL port 20a. In this case, the RPL for the primary ring remains blocked.

In this exemplary embodiment, a link between two normal nodes in the sub-ring failed. Forwarding data may also be copied from one ring port to the other ring port, instead of flushing the forwarding data when there is a failure on a sub-ring, as long as the node that failed is a normal node, i.e., not an interconnected node in the sub-ring. Instead of having all nodes clearing or flushing their forwarding data when a failure occurs, the nodes in the primary ring and the sub-ring that are not adjacent to the failed link may need to flush their corresponding forwarding data, which may be in the form of a forwarding database. Nodes adjacent to the failed link may not need to flush their forwarding data after the failure. As such, no flushing of the forwarding data may be required for nodes E 12E and F 12F.

However, nodes A 12A, B 12B, C 12C and D 12D may flush their forwarding data, which forces these nodes to relearn the network topology. Instead of flushing their forwarding data, nodes E 12E and F 12F may copy the forwarding data associated with their ports adjacent to the failed link, to the forwarding data associated with their other port, i.e., the port not adjacent to the failed link. For example, before the link failure, packets addressed to at least one of nodes A 12A, B 12B, C 12C, D 12D and F 12F were forwarded via port 20b of node E 12E, and no packets were forwarded via port 20a of node E 12E, as port 20a is the RPL port for the sub-ring. After the failure, node E 12E copies the forwarding data associated with the port adjacent to the failure, i.e., port 20b, to forwarding data associated with port 20a.

As such, after the failure, the forwarding data of node E 12E may indicate that packets addressed to nodes A 12A, B 12B, C 12C, D 12D and F 12F may be forwarded through port 20a and not through port 20b. As an exemplary embodiment, when a link failure happens in the sub-ring between normal nodes, such as nodes E 12E and F 12F, nodes E 12E and F 12F may copy the MAC addresses of each of their ports that detected the failure to their other port. The forwarding databases corresponding to normal sub-ring nodes E 12E and F 12F may not need to be flushed in order to learn which nodes are accessible through which ports.

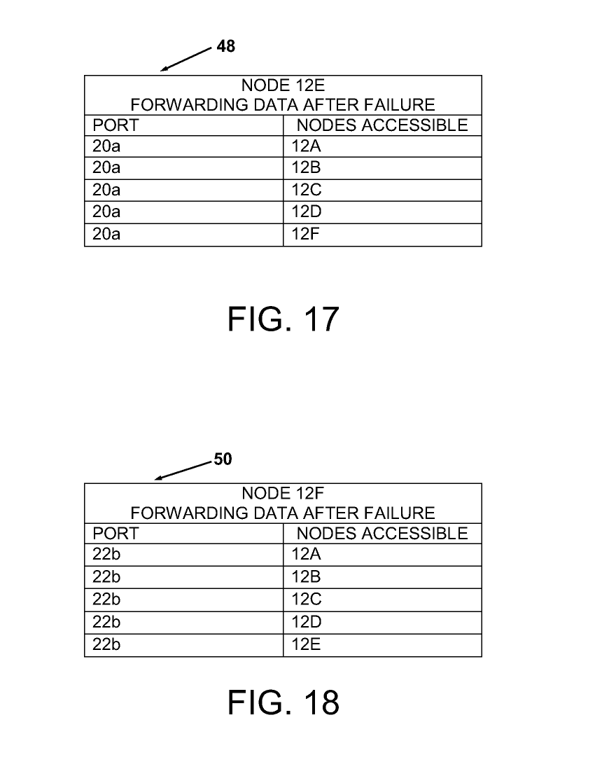

FIG. 17 is exemplary forwarding data 48 for node E 12E after failure on the sub-ring, i.e., after the link between nodes E 12E and F 12F failed. Forwarding data 48 may indicate that packets received at node E 12E that are associated with a node identification that may include the MAC address of at least one of destination nodes A 12A, B 12B, C 12C, D 12D and F 12F, are forwarded through port 20a. As such, if node E 12E receives a packet that indicates node F 12F as the destination node, node E 12E may use port 20a to send the packet to node F 12F. No packets may be sent via port 20b.

FIG. 18 is exemplary forwarding data 50 for node F 12F after failure on the ring, i.e., after the link between nodes E 12E and F 12F failed. Forwarding data 50 may include information regarding which nodes 12 are accessible through which ports of node F 12F. Forwarding data 50 may indicate that packets received that are associated with a node identification that may include the MAC address of at least one of destination nodes A 12A, B 12B, C 12C, D 12D and E 12E are forwarded through port 22b. As such, if node F 12F receives a packet that indicates node E 12E as the destination node, node F 12F may use port 22b to send the packet to node E 12E. No packets may be sent via port 22a.

FIG. 19 is a schematic illustration of exemplary network 51. Network 51 includes a primary ring and a sub-ring. The primary ring includes nodes A 12A, B 12B, C 12C and D 12D. The sub-ring includes nodes E 12E and F 12F. Nodes B 12B and C 12C are interconnecting nodes that interconnect the primary ring with the sub-ring. Although, FIG. 19 shows exemplary nodes A 12A-F 12F, the invention is not limited to such, as any number of nodes may be included in the ring. Further, the invention may be applied to a variety of network sizes and configurations.

A link between node A 12A and D 12D may be the RPL for the primary ring, and a link between node E 12E and node F 12F may be the RPL for the sub-ring. Under normal state, both RPLs may be blocked and not used for service traffic. Node A 12A may be the RPL owner node for the primary ring and node E 12E may be the RPL owner node for the sub-ring. The RPL owner nodes and the partner nodes may be configured to block traffic on a port at one end of the corresponding RPL. For example, in the sub-ring, node E 12E may block port 20b. Node F 12F may be the RPL partner node for the sub-ring and may block its port 22a during normal state.

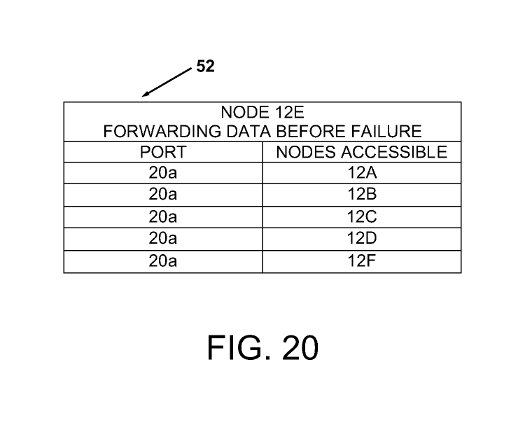

FIG. 20 is exemplary forwarding data 52 for node E 12E during normal state of the ring, i.e., when there is no failure on either the primary ring or the sub-ring. Forwarding data 52 may include information regarding how to route packets to nodes 12 through which ports of node E 12E. Forwarding data 52 may also contain the routing configuration from the point of view of node E 12E. Forwarding data 52 may indicate that packets addressed to at least one of nodes A 12A, B 12B, C 12C, D 12D and F 12F, for example, packets received by node E 12E that are associated with a node identification that may include the MAC address of at least one of destination nodes A 12A, B 12B, C 12C, D 12D and F 12F, are forwarded through port 20a. This is because port 20b is connected to the RPL, and during normal operation port 20b may be blocked. As such, if node E 12E receives a packet that indicates node F 12F as the destination node, node E 12E may use port 20a to send the packet to node F 12F.

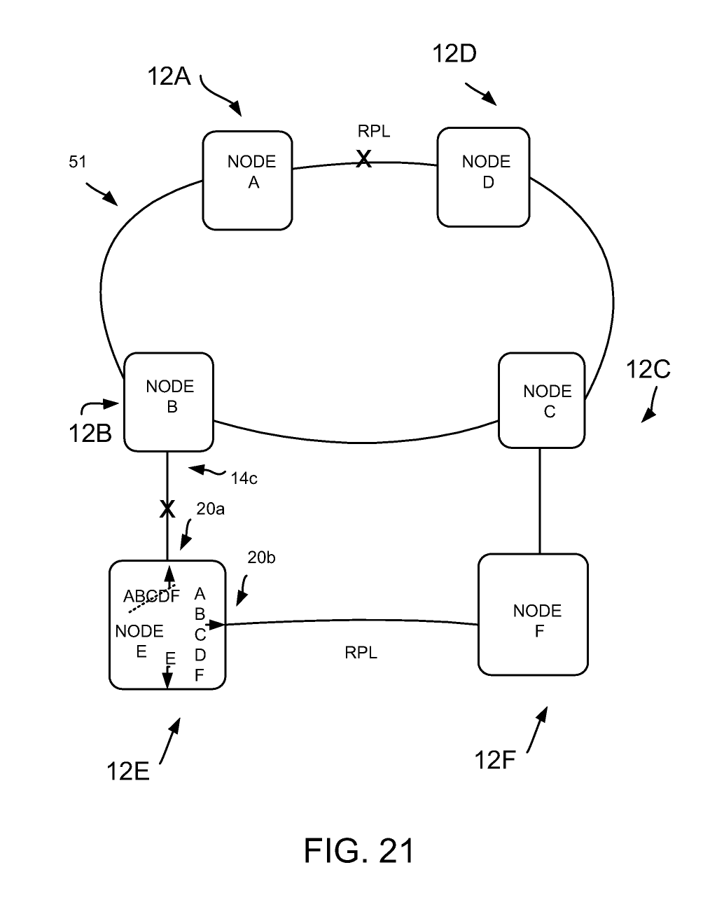

FIG. 21 is a diagram of the network of FIG. 19 showing a link failure in the sub-ring between nodes E 12E and B 12B. When a link in the ring fails, a protection switching mechanism may redirect traffic away from the failure. Nodes E 12E and B 12B may block a port detected or adjacent to the failed link. Node E 12E may block port 20a and node B 12B may block port 14c. When a failure happens in a link between an interconnected node, i.e., node B 12B, and a normal node inside the sub-ring, i.e., node E 12E, the normal node in the sub-ring may copy forwarding data associated with its port that detected the failure or adjacent to the failure, to forwarding data associated with the other port, instead of flushing forwarding data to redirect traffic. On the other hand, the interconnected node may need to flush its forwarding data to learn the network topology after the failure.

In an exemplary embodiment, node E 12E may detect the failure and may send out a R-APS (SF, flush request) request message inside the sub-ring to coordinate protection switching with the nodes in the sub-ring. Similarly, node B 12B may detect the failure and may send a R-APS (Event, flush request) message to the nodes in the primary ring. Node E 12E, the node that detected the failure, may copy forwarding data associated with port 20a to forwarding data associated with port 20b. However, the interconnected node, i.e., node B 12B, may need to flush its forwarding data to repopulate its forwarding data associated with both ports after the failure. As such, node B 12B may need to relearn MAC addresses for its forwarding database. The RPL owner node of the sub-ring, i.e., node E 12E, may unblock its RPL port 20b, so that the RPL may be used for traffic. In this case, the RPL of the primary ring remains blocked.

In this exemplary embodiment, instead of having all nodes clearing or flushing their forwarding data when a failure occurs, the normal node, i.e., the non-interconnected node, that detected the failure in the sub-ring does not flush its forwarding data. All nodes, but the non-interconnected node that detected the failure, flush their forwarding data, which may be in the form of a forwarding database. As such, the interconnected node adjacent to the failure may need to flush its forwarding data, just like the other nodes that are non-adjacent to the failed link.

While no flushing of the forwarding data may be required for node E 12E, nodes A 12A, D 12D, B 12B, C 12C and F 12F may flush their forwarding data. But, in this exemplary embodiment, node A 12A and node D 12D do not need to flush their forwarding data given that the logical traffic path inside the primary ring has not changed. As such, if a failure happens in the sub-ring, the RPL owner and RPL partner node in the primary ring do not need to flush their forwarding data.

Normal sub-ring node E 12E may not flush its forwarding data. Instead, normal sub-ring node E 12E may copy forwarding data associated with its port that detected the signal failure, to the forwarding data associated with its other port, i.e., the port not adjacent to the failed link. For example, before the link failure, packets addressed to at least one of nodes A 12A, B 12B, C 12C, D 12D and F 12F were forwarded via port 20a of node E 12E, and no packets were forwarded via port 20b of node E 12E, as port 20b is adjacent to the RPL port. After the failure, node E 12E copies the forwarding data associated with port 20a adjacent to the failure, to forwarding data associated with port 20b. As such, after the copying of the forwarding data of node E 12E, the forwarding data will indicate that packets addressed to nodes A 12A, B 12B, C 12C, D 12D and F 12F are forwarded through port 20b and not through port 20a.

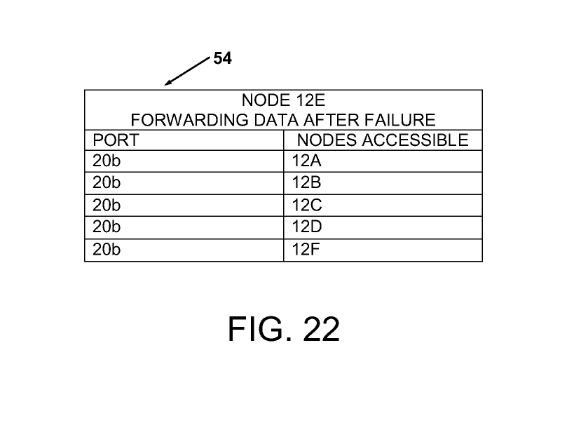

FIG. 22 shows exemplary forwarding data 54 for node E 12E after failure on the sub-ring, i.e., after failure in the link between normal sub-ring node E 12E and interconnected node B 12B. Forwarding data 54 may indicate that packets addressed to nodes A 12A, B 12B, C 12C, D 12D and F 12F, for example, packets that are associated with a node identification that may include the MAC address of at least one of destination nodes A 12A, B 12B, C 12C, D 12D and F 12F, are forwarded through port 20b. As such, if node E 12E receives a packet that indicates node F 12F as the destination node, node E 12E may use port 20b to send the packet to node F 12F. No packets may be sent via port 20a.

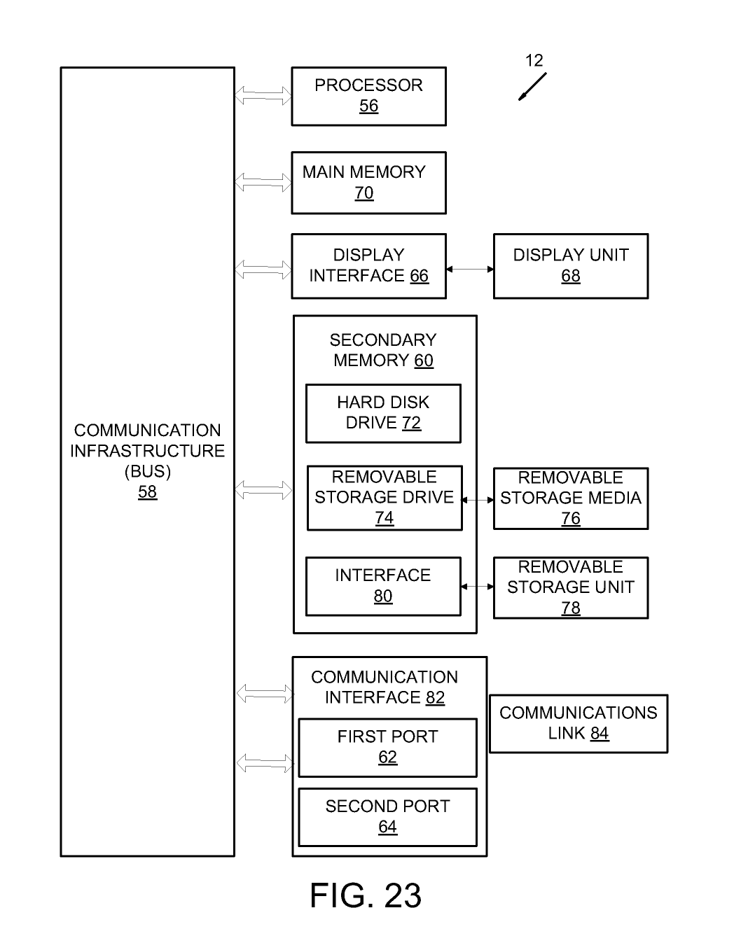

FIG. 23 shows an exemplary network node 12 constructed in accordance with principles of the present invention. Node 12 includes one or more processors, such as processor 56 programmed to perform the functions described herein. Processor 56 is operatively coupled to a communication infrastructure 58, e.g., a communications bus, cross-bar interconnect, network, etc. Processor 56 may execute computer programs stored on a volatile or non-volatile storage device for execution via memory 70. Processor 56 may perform operations for storing forwarding data corresponding to at least one of first port 62 and second port 64.

In an exemplary embodiment, processor 56 may be configured to determine a failure associated with one of first port 62 and second port 64. Upon determining a failure on the ring, processor 56 may determine which one of first port 62 and second port 64 is associated with the failure, i.e., which port is the port that detected the failure or is adjacent to the failure. Processor 56 may update forwarding data corresponding to the port not associated with the failure, with forwarding data corresponding to the port associated with the failure. First port forwarding data may include information on at least one node accessible via first port 62, and second port forwarding data may include information on at least one node accessible via second port 64. Processor 56 may generate a signal to activate the RPL when a failure in the ring has been detected. Processor 56 may request that nodes not adjacent to the failed link or failed node, flush their forwarding data. Processor 56 may redirect traffic directed to the port associated with the failure to the other port, i.e., the port not associated with the failure.

In another exemplary embodiment, processor 56 may determine whether the failure happened on a sub-ring. If so, processor 56 may determine whether the node that detected the failure is a normal node on the sub-ring. Normal node 12 may be one of the nodes in the sub-ring that detected the failure, i.e., one of the nodes adjacent to the failed link. If the failure happened on the sub-ring and the node that detected the failure is a normal node in the sub-ring, then processor 56 may copy forwarding data associated with the port of node 12 that detected the failure, to the forwarding data associated with the other port. As such, when processor 56 determines that the failed link is between two normal nodes on the sub-ring and node 12 is one of the two normal nodes, then processor 56 may copy forwarding data associated with the port of node 12 that detected the failure, to the other port, instead of having node 12 flush its forwarding data. All other nodes not adjacent to the failure may flush their forwarding data.

In another exemplary embodiment, an interconnected node may be a node that is part of both a primary ring and a sub-ring. Processor 56 may determine that the failed link is on the sub-ring, and that an interconnected node 12 is at one end of the failed link, i.e., interconnected node 12 detects the failure. When the link failure happens between an interconnected node and a normal node inside the sub-ring, the normal node inside the sub-ring may copy forwarding data associated with the port of the normal node that detected the failure, to forwarding data associated with the other port of the normal node. The normal node may not flush its forwarding data.

The normal node may copy the MAC addresses of the forwarding database entries associated with the port that detected the failure, to the forwarding database entries associated with the other port. However, the interconnected node adjacent to the failure may flush its forwarding data in order to relearn and repopulate its forwarding data. Processor 56 may command the interconnected node to flush its forwarding database in order to relearn MAC addresses. The forwarding data copying mechanism may not be suitable for an interconnected node adjacent to a failure. The normal node at the other end of the failed link may send out R-APS (SF, flush request) to nodes in the sub-ring. Similarly, the interconnected node that detected the failure may send R-APS (Event, flush request) inside the primary ring.

Various software embodiments are described in terms of this exemplary computer system. It is understood that computer systems and/or computer architectures other than those specifically described herein can be used to implement the invention. It is also understood that the capacities and quantities of the components of the architecture described below may vary depending on the device, the quantity of devices to be supported, as well as the intended interaction with the device. For example, configuration and management of node 12 may be designed to occur remotely by web browser. In such case, the inclusion of a display interface and display unit may not be required.

Node 12 may optionally include or share a display interface 66 that forwards graphics, text, and other data from the communication infrastructure 58 (or from a frame buffer not shown) for display on the display unit 68. Display 68 may be a cathode ray tube (CRT) display, liquid crystal display (LCD), light-emitting diode (LED) display, and touch screen display, among other types of displays. The computer system also includes a main memory 70, such as random access memory (“RAM”) and read only memory (“ROM”), and may also include secondary memory 60. Main memory 70 may store forwarding data in a forwarding database or a filtering database.

Memory 70 may store forwarding data that includes first port forwarding data identifying at least one node accessible via first port 62. Additionally, memory 70 may store forwarding data that includes second port forwarding data identifying at least one node accessible via second port 64. Forwarding data may identify the at least one accessible node using a Media Access Control (“MAC”) address and a VLAN identification corresponding to the at least one accessible node. Memory 70 may further store routing data for node 12, and connections associated with each node in the network.

Secondary memory 60 may include, for example, a hard disk drive 72 and/or a removable storage drive 74, representing a removable hard disk drive, magnetic tape drive, an optical disk drive, a memory stick, etc. The removable storage drive 74 reads from and/or writes to a removable storage media 76 in a manner well known to those having ordinary skill in the art. Removable storage media 76, represents, for example, a floppy disk, external hard disk, magnetic tape, optical disk, etc. which is read by and written to by removable storage drive 74. As will be appreciated, the removable storage media 76 includes a computer usable storage medium having stored therein computer software and/or data.

In alternative embodiments, secondary memory 60 may include other similar devices for allowing computer programs or other instructions to be loaded into the computer system and for storing data. Such devices may include, for example, a removable storage unit 78 and an interface 80. Examples of such may include a program cartridge and cartridge interface (such as that found in video game devices), flash memory, a removable memory chip (such as an EPROM, EEPROM or PROM) and associated socket, and other removable storage units 78 and interfaces 80 which allow software and data to be transferred from the removable storage unit 78 to other devices.

Node 12 may also include a communications interface 82. Communications interface 82 may allow software and data to be transferred to external devices. Examples of communications interface 82 may include a modem, a network interface (such as an Ethernet card), communications ports, such as first port 62 and second port 64, a PCMCIA slot and card, wireless transceiver/antenna, etc. For example, first port 62 may be port 11a of node A 12A, port 14a of node B 12B, port 16a of node C 12C, port 18a of node D 12D, port 20a of node E 12E, and port 22a of node F 12F. Second port 64 may be port 11b of node A 12A, port 14b of node B 12B, port 16b of node C 12C, port 18b of node D 12D, port 20b of node E 12E and port 22b of node F 12F.

Software and data transferred via communications interface/module 82 may be, for example, electronic, electromagnetic, optical, or other signals capable of being received by communications interface 82. These signals are provided to communications interface 82 via the communications link (i e, channel) 84. Channel 84 carries signals and may be implemented using wire or cable, fiber optics, a phone line, a cellular phone link, an RF link, and/or other communications channels.

It is understood that node 12 may have more than one set of communication interface 82 and communication link 84. For example, node 12 may have a communication interface 82/communication link 84 pair to establish a communication zone for wireless communication, a second communication interface 82/communication link 84 pair for low speed, e.g., WLAN, wireless communication, another communication interface 82/communication link 84 pair for communication with optical networks, and still another communication interface 82/communication link 84 pair for other communication.

Computer programs (also called computer control logic) are stored in main memory 70 and/or secondary memory 60. For example, computer programs are stored on disk storage, i.e. secondary memory 60, for execution by processor 56 via RAM, i.e., main memory 70. Computer programs may also be received via communications interface 82. Such computer programs, when executed, enable the method and system to perform the features of the present invention as discussed herein. In particular, the computer programs, when executed, enable processor 56 to perform the features of the corresponding method and system. Accordingly, such computer programs represent controllers of the corresponding device.

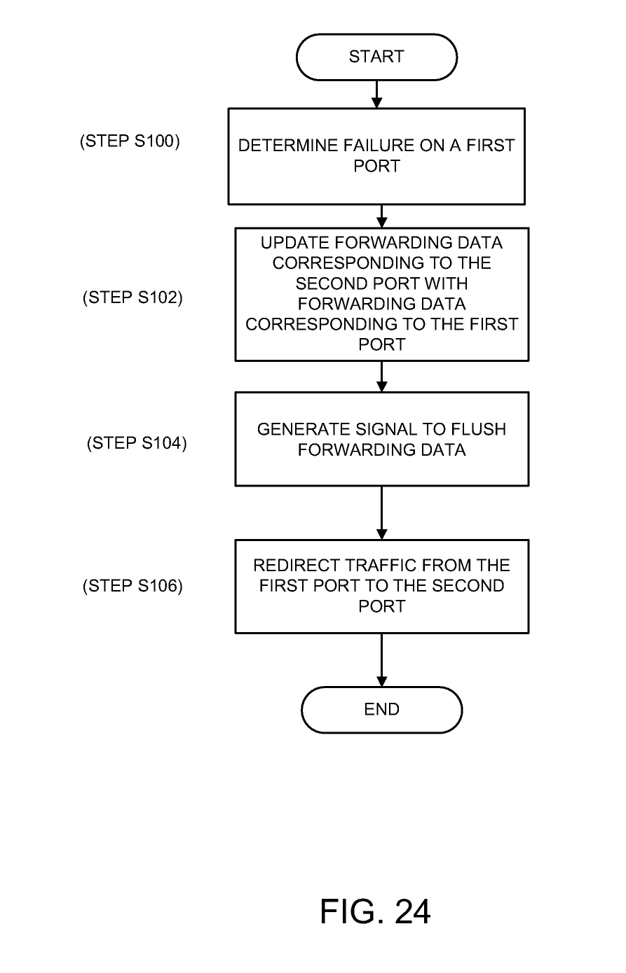

FIG. 24 is a flow chart of an exemplary process for restoring a connection on a ring in accordance with principles of the present invention. The ring may include multiple nodes, each having first port 62 and second port 64. Each node 12 may store forwarding data including first port forwarding data and second port forwarding data. First port forwarding data may identify at least one node accessible via the first port, and second port forwarding data may identify at least one node accessible via the second port. Forwarding data may include a MAC address associated with at least one node accessible via a port of node 12.

Node 12 may be a failure detect node and may determine a failure associated with first port 62 (Step S100). Upon determining that no nodes may be accessed via first port 62 due to the failure on the ring, node 12 may update forwarding data corresponding to second port 64, i.e., the port that did not detect the failure. Node 12 may update forwarding data corresponding to second port 64 with forwarding data corresponding to first port 62, i.e., the port that detected the failure (Step S102). In an exemplary embodiment, node 12 may copy the MAC addresses of nodes that were accessible (before the failure) via first port 62, to forwarding data of second port 64. Second port forwarding data may then include the MAC addresses of the nodes that, before the failure, were accessible via first port 62. The nodes that were accessible via first port 62 may now be accessible via second port 64. Node 12 may generate a signal requesting that all nodes in the ring that are not adjacent to the failure flush their forwarding data (Step S104). Traffic may be redirected from first port 62 to second port 64 (Step S106).

The present invention can be realized in hardware, or a combination of hardware and software. Any kind of computing system, or other apparatus adapted for carrying out the methods described herein, is suited to perform the functions described herein. A typical combination of hardware and software could be a specialized computer system, having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A network node, the network node comprising:
a first port;
a second port;
a memory storage device, the memory storage device configured to store forwarding data, the forwarding data including first port forwarding data identifying at least one node accessible via the first port, and second port forwarding data identifying at least one node accessible via the second port;
a processor in communication with the memory, the first port and the second port, the processor:
determining a failure associated with one of the first port and the second port; and
updating the forwarding data corresponding to the other of the first port and the second port not associated with the failure, with the one of the first port forwarding data and second port forwarding data corresponding to the one of the first port and the second port associated with the failure.

2. The network node of claim 1, wherein forwarding data identifies the at least one accessible node using a corresponding Media Access Control, MAC, address.

3. The network node of claim 1, wherein the processor generates a signal to activate a Ring Protection Link, RPL upon determining the failure.

4. The network node of claim 1, wherein the processor requests the at least one node accessible via the one first port and the second port not associated with the failure to flush forwarding data.

5. The network node of claim 1, wherein the processor redirects traffic directed to the one of the first port and the second port associated with the failure to the one of the first port and the second port not associated with the failure.

6. The network node of claim 1, wherein the failure associated with the one of the first port and the second port is a link transmission failure.

7. The network node of claim 1, wherein the node is an Ethernet Protection Ring node.

8. A method for reducing congestion on a communication network, the communication network including a network node having a first port and a second port, the network node being associated with forwarding data including first port forwarding data identifying at least one node accessible via the first port, and second port forwarding data identifying at least one node accessible via the second port, the method comprising:
determining a failure associated with one of the first port and the second port; and
updating the forwarding data corresponding to the other of the first port and the second port not associated with the failure, with the one of the first port forwarding data and second port forwarding data corresponding to the one of the first port and the second port associated with the failure.

9. The method of claim 8, wherein forwarding data identifies the at least one accessible node using a corresponding Media Access Control, MAC, address.

10. The method of claim 8, further comprising:
generating a signal to activate a Ring Protection Link, RPL upon determining the failure.

11. The method of claim 8, further comprising:
requesting the at least one node accessible via the one first port and the second port not associated with the failure to flush forwarding data.

12. The method of claim 8, further comprising:
redirecting traffic directed to the one of the first port and the second port associated with the failure to the one of the first port and the second port not associated with the failure.

13. The method of claim 8, wherein the failure associated with the one of the first port and the second port is a link transmission failure.

14. A computer readable storage medium storing computer readable instructions that when executed by a processor, cause the processor to perform a method comprising:
storing forwarding data associated with a network node, the forwarding data including first port forwarding data identifying at least one node accessible via a first port of the network node, and second port forwarding data identifying at least one node accessible via a second port of the network node;
determining a failure associated with one of the first port and the second port; and
updating the forwarding data corresponding to the other of the first port and the second port not associated with the failure, with the one of the first port forwarding data and second port forwarding data corresponding to the one of the first port and the second port associated with the failure.

15. The computer readable storage medium of claim 14, wherein forwarding data identifies the at least one accessible node using a corresponding Media Access Control, MAC, address.

16. The computer readable storage medium of claim 14, the method further comprising:
generating a signal to activate a Ring Protection Link, RPL upon determining the failure.

17. The computer readable storage medium of claim 14, the method further comprising:
requesting the at least one node accessible via the one first port and the second port not associated with the failure to flush forwarding data.

18. The computer readable storage medium of claim 14, the method further comprising:
redirecting traffic directed to the one of the first port and the second port associated with the failure to the one of the first port and the second port not associated with the failure.

19. The computer readable storage medium of claim 14, wherein the failure associated with the one of the first port and the second port is a link transmission failure.

20. The computer readable storage medium of claim 14, wherein the forwarding data includes a forwarding database entry.
